(19) United States
(12) Patent Application Publication
(10) Pub. No.: US 2019/0351949 A1
(43) Pub. Date: Nov. 21, 2019

(54) ADJUSTABLE MUD FLAP ASSEMBLY AND ASSOCIATED MUD FLAP

(71) Applicants: Josh Kinney, New Philadelphia, OH (US); Allen Milarcik, New Philadelphia, OH (US)

(72) Inventors: Josh Kinney, New Philadelphia, OH (US); Allen Milarcik, New Philadelphia, OH (US)

(21) Appl. No.: 16/413,088

(22) Filed: May 15, 2019

Related U.S. Application Data
(60) Provisional application No. 62/673,422, filed on May 18, 2018.

(51) Int. Cl. B62D 25/18; B60Q 1/00; B60Q 1/26; F21V 23/00

(52) U.S. Cl. CPC B62D 25/182; F21V 23/001; B60Q 1/2661; B60Q 1/0088

(57) ABSTRACT

The present disclosure is directed to an adjustable mud flap assembly and associated mud flap material. The adjustable mud flap assembly includes a motor, a motor housing, a mud flap extension bar connected to the motor housing, a sheet of mud flap material wrapped around a drive bar which is housed within a mud flap extension bar and a motor drive shaft which rotates or drives operation of the drive bar and the extension or retraction of the mud flap material from an opening at the bottom side of the mud flap extension bar.

### PRIORITY

This utility application claims the benefit of U.S. Provision Patent Application No. 62/673,422 filed on May 18, 2018, the entirety of which is hereby incorporated by reference.

### TECHNICAL FIELD

The present disclosure is directed to an adjustable mud flap assembly. The adjustable mud flap assembly allows for mud flaps to be raised and lowered as needed behind the wheels of a commercial vehicle. It also allows for replacement mud flaps to be readily installed and/or deployed behind the vehicle as needed when the previous installed mud flap becomes worn or is damaged.

### BACKGROUND

Mud flaps are required under state laws to be installed behind the rear wheels of trucks to prevent debris from being kicked up from the road and hitting other vehicles travelling alongside or behind the truck.

All states have Department of Transportation laws and regulations which require mud flaps to be installed at a certain height from the ground in order to provide sufficient protection to passengers of other vehicles from road debris. Over time, however, mud flaps can become damaged and worn from repeated use.

As the mud flaps wear down, they tend to become shorter. This can cause a problem for truckers who must meet certain height requirements set by the Department of Transportation with respect to the installation of mud flaps.

Moreover, mud flaps have a tendency to get caught in the wheel when the vehicle is placed in reverse which results in the mud flap being ripped or be tom off of the truck. This poses a significant problem for truckers in lost time and lost production to repair or replace the mud flaps before they can continue their travel.

Replacing mud flaps is inconvenient and time consuming especially if a new set of mud flaps is not readily available. Even if a new set of mud flaps are available, the time required to install the mud flaps results in delayed deliveries and increased shipping costs.

What is needed is a new and improved device which is capable of deploying a new mud flap when a mud flap has become worn or damaged and which can retract a mud flap when a vehicle is placed in reverse to prevent the mud flap from catching on a vehicle's wheels and being tom or ripped off.

### BRIEF DESCRIPTION OF THE DRAWINGS

FIG. 1 is a perspective view of an exemplary adjustable mud flap assembly.

FIG. 2 is planar view of a drive bar which is a component of the adjustable mud flap assembly shown in FIG. 1.

FIG. 3 is a perspective view of a mud flap extension bar which is a component of the adjustable mud flap assembly shown in FIG. 1.

FIG. 4 is an inside back view of the mud flap extension bar containing a drive bar and a sealed bearing positioned within the mud flap extension bar.

FIG. 5 is a planar view of a mud flap extension bar containing brake, tail and turn signal lights.

### DETAILED DESCRIPTION

Provided is an adjustable mud flap assembly and associated mud flap that may be attached to a vehicle's frame and positioned behind the wheels of a vehicle. The adjustable mud flap assembly may be used on any type of vehicle but is particularly suited for use in commercial, large-scale industrial trucking applications including but not limited to cross country trucks such as semi-trailers or tractor-trailers, dump trucks and large service trucks. Moreover, the adjustable mud flap assembly disclosed herein may be installed on both trucks and/or trailers.

The adjustable mud flap assembly disclosed herein and the associated mud flap that is deployed is designed to comply with all Department of Transportation rules and regulations.

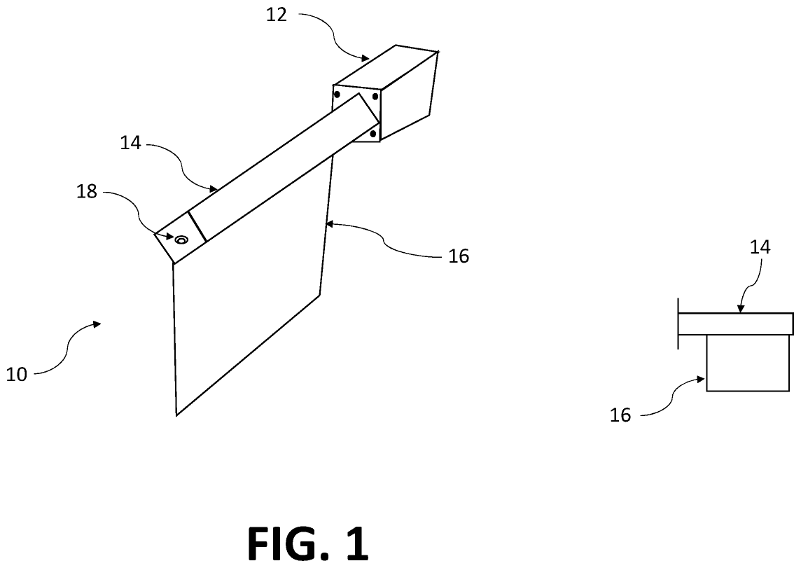

The following description of the adjustable mud flap assembly includes references to various components illustrated within FIGS. 1, 2, 3 and 7 where appropriate. An exemplary embodiment of an adjustable mud flap assembly (10) is illustrated within FIG. 1. The adjustable mud flap assembly (10) includes a motor housing (12) and a mud flap extension bar (14) which extends out from the side of the motor housing (12). Extending downward from the bottom side of the mud flap extension bar (14) is a mud flap or mud flap material (16).

According to certain embodiments, the motor housing (12) is attached to a frame on the back side of a vehicle or to the back side of a trailer attached to a vehicle and is positioned such that the mud flap will extend downward from the mud flap extension bar (14) behind the rear of a wheel.

According to further aspects of the present teaching, a bracket is used to attach the motor housing to a frame on the vehicle. According to certain aspects of the present teaching, the adjustable mud flap assembly includes a motor (42) connected to a single mud flap extension bar (14) which extends outward from one side of the motor housing (12).

In such embodiments, the vehicle will include two adjustable mud flap assemblies (10) positioned on the frame at the rear of the vehicle with each adjustable mud flap assembly (10) positioned behind one of the rear wheels. In other words, one adjustable mud flap assembly may be installed for each wheel bay on either side of the vehicle. Installation may be accomplished by bolting the mud flap assembly onto the frame of the vehicle. For example, a bracket may include a first side connected to the motor housing and a second side which includes bolts attaching the bracket, motor housing and mud flap assembly to the frame of the vehicle.

In other embodiments, the motor may be connected to two mud flap extension bars on opposing sides of the motor with each mud flap extension bar extending outward from opposing sides of the motor housing. In such embodiments, the vehicle will include a single adjustable mud flap assembly positioned on the frame at the rear of the vehicle.

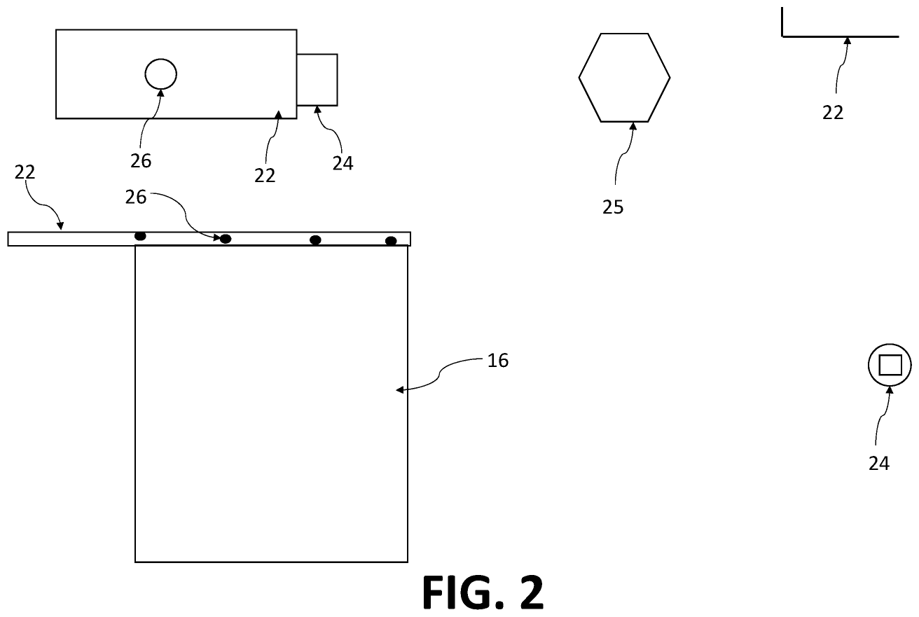

A first mud flap extension bar will extend outward from a first side of the motor housing behind the rear wheel(s) on a first back side of a vehicle and a second mud flap extension bar will extend outward from a second side of the motor housing behind the rear wheel(s) on a second back side of a vehicle. In both embodiments, a bracket may be used to attach the motor housing to the frame on the vehicle. Inside mud flap extension bar (14) is a drive bar (22) (shown in FIG. 2) which rotates in a first or second direction to raise or lower the mud flap (16).

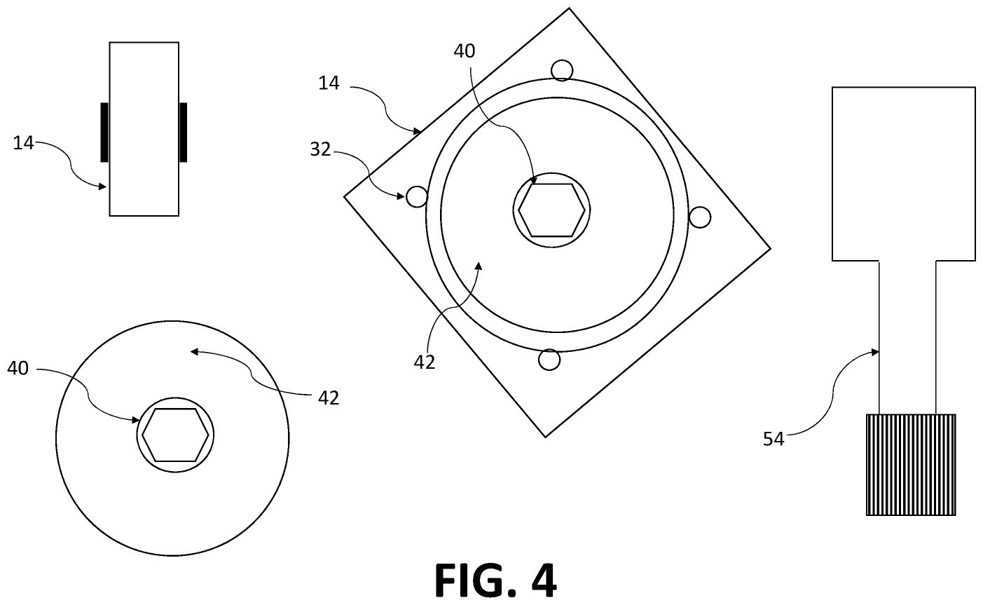

The drive bar is connected to a motor shaft end (28) which extends from the motor (42) within the motor housing (12). Specifically, the motor shaft end (28) is located at the end of a motor gear (56) and shaft (54) (shown in FIG. 4). Operation of the motor may thus cause the drive bar (22) to rotate causing the mud flap (16) to raise or lower to a desired height with respect to the ground. The height of the mud flap with respect to the ground is based on Department of Transportation requirements. For example, the motor may include a computing mechanism which allows it to be pre-programmed to deploy the mud flap at various heights with respect to the ground in accordance with Department of Transportation requirements.

The motor may also be pre-programmed to raise or lift the mud flap when the vehicle is placed in reverse. For example, the motor may be pre-programmed to raise or lift the mud flap so that its height is ½, ¾ or ¼ of its deployable length when the vehicle is placed in reverse.

According to other aspects of the present teaching, the drive bar (22) may be operated manually to lower the mud flap (16). This may be accomplished in one of two ways. A first way for lowering the mud flap (16) manually is for an operator to rotate an adjuster (18) located at the end of the mud flap extension bar (14). The adjuster (18) may be comprise any type of shaft work transmission element such as a prism socket or prism protrusion which allows an operator to turn the adjuster (18) and rotate the drive bar (22) with a tool.

In certain embodiments, the adjuster (18) may comprise a socket which may be turned with a drive square or a prism protrusion on a driver tool. In other embodiments, the adjuster (18) may comprise a prism protrusion which may be turned with a wrench or socket on a driver tool. In further embodiments, the adjuster (18) may comprise a screw which may be turned with a screw driver.

A second way the mud flap (16) may be lowered is for an operator to grab the lower end of the mud flap (16) and manually pull the mud flap (16) down.

According to further aspects of the present teaching, the drive bar (22) and mud flap material wound around the drive bar (22) may form a cartridge which may be inserted within the mud flap extension bar (14).

In such embodiments, the mud flap extension bar (14) also serves as a housing which holds a cartridge comprising the drive bar and mud flap material. As such, the mud flap extension bar (14) may include a portal and an associated cover plate or door which may be openable and closable allowing an operator to insert and remove the cartridge from the inside of the mud flap extension bar (14). A series of bolts or wingnuts may be used to secure the cover plate or door in place to the mud flap extension bar (14).

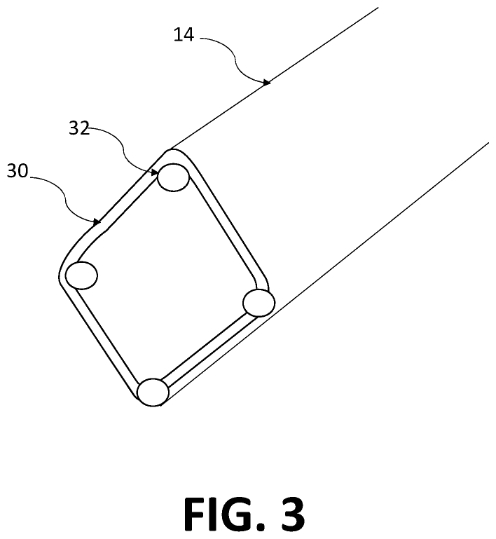

In certain embodiments, the mud flap extension bar (14) includes a cover plate or end cap (30) located at its free end and four bolts or wingnuts (30) may be used to secure the end cap (30) to the mud flap extension bar as shown in FIG. 3.

It is understood that the number of bolts or wingnuts used may vary depending on design of the cover plate or door and that the device may include any type of fastening mechanism suitable within the art. The cover plate or door may be located at the free end of the mud flap extension bar or at a point around the circumference or perimeter of the mud flap extension bar.

As mentioned above, an end cap or cover plate may be located at the free end of the mud flap extension bar and a series of four bolts or wingnuts may be used to secure the end cap or cover plate to the mud flap extension bar. When these four bolts or wingnuts are removed, the end cap or cover plate may be removed providing an opening for the old cartridge to slide out of the mud flap extension bar and removed. A new cartridge stored within the vehicle may then be inserted into the mud flap extension bar. Thus, the cartridge within the mud flap extension bar (14) may be replaced with a new cartridge as mud flap material that is rolled around the drive bar is used up. Cartridges can thus be quickly and easily replaced in the field as needed. This allows the vehicle to remain on the road without having to make a longservice stop.

As mentioned above, the cartridge includes the drive bar (22). The drive bar (22) may also be referred to as a conveyer or roller. The drive bar (22) includes a first end positioned towards the motor which connects the drive bar (22) to the drive shaft end (28) of the drive shaft (54) of the motor (42). This allows the motor (42) to rotate the drive bar (22). The drive bar (22) also includes a second end which may be connected to the adjuster (18) located at the free end of the mud flap extension bar (14). This configuration allows an operator to manually rotate the drive bar (22) or cartridge by turning the adjuster (18). Wrapped around the drive bar (22) or cartridge is an extendable mud flap material.

As shown within FIG. 2, the drive bar (22) may include a series of threaded holes (26) for receiving a fastener which secures the mud flap material to the drive bar (22). Once one end of the mud flap material is secured to the drive bar (22), the mud flap material may be wrapped or wound around the drive bar (22). The extendable mud flap material is made from a material which is sufficiently flexible to be wrapped around the drive bar (22). The drive bar (22) allows the mud flap to be extended or retracted as necessary from the mud flap extension bar (14). Due to the flexibility of mud flap material, the mud flap is capable of being unwound from the drive bar (22) in a substantially flat configuration, that is, without significantly curling at its end due to having been wound around the conveyor or roller.

According to certain aspects of the present teaching, the mud flap material is a “mime-type” conveyor belt material which provides sufficient flexibility to wrap around the drive bar (22) but also provides sufficient durability, structural integrity and rigidity to deflect debris that is thrown upwards from the road. According to further aspects of the present teaching, the mud flap material includes perforations at various portions along the length of the material. These perforations are sufficiently strong to support the deployed mud flap material.

However, when a portion of the deployed mud flap becomes worn, damaged, deteriorated or is no longer functioning properly, the perforations allow an operator to rip or tear the deployed mud flap from the overall mud flap material. The operator may tear the old mud flap along a perforation within the mud flap material by pulling the mud flap (16) in a downward direction. After tearing the old mud flap along the perforation, the operator may discard the used and worn mud flap material. The operator may then pull or extend down a new mud flap material from the cartridge to the required height from the ground, thereby establishing a new mud flap for use.

The perforations on the mud flap material may be marked or labeled to identify the “tear off points”. For example, the perforations may be marked with indicia or may be color coded (e.g., with a color-coded line) to note the “tear off points”. Likewise, the bottom end of the deployed mud flap may also be marked or labeled to identify when the bottom of the mud flap has achieved a certain degree of wear, deterioration or chafing so as to indicate that it is no longer the required length or height from the ground as set by the Department of Transportation. The marking or labeling of the bottom end of the mud flap may also be with indicia or a color-coded line to note when the mud flap has become too short and warrant being replaced with a new mud flap material.

To provide further support to the mud flap, a weighted bar (20) may be attached to the bottom end of the mud flap (16) that extends out from the mud flap extension bar (14). The weighted bar may provide support to the mud flap and assist in allowing the mud flap to maintain a substantially flat configuration while also preventing the mud flap from hitting up against the wheels of the vehicle during travel. The weighted bar is also of a sufficient weight so as not to cause the mud flap to rip or tear away from the perforations incorporated in the mud flap material. The weighted bar may be made out of any suitable material for providing a sufficient weight to the bottom end of the mud flap.

For example, the weighted bar may be made from a metal such as steel or aluminum and may be used to provide a weight to stabilize the mud flap as the vehicle travels along the road. This weight prevents the mud flap from wildly flapping back and forth in an uncontrolled manner while the vehicle is traveling and reduces movement of the mud flap due to movement of the vehicle, wind and other road conditions.

According to further aspects of the present teaching, the adjustable mud flap assembly may include a scraper at the bottom end of the mud flap extension bar. The scraper provides a tight tolerance or opening on the front and back side of the mud flap. The tight tolerance or opening provided by the scraper within the mud flap extension bar allows the mud flap to be held securely within the mud flap extension bar so that the mud flap material does not inadvertently extend or retract during use. The scraper also provides a means to clean debris from the front and back side of the mud flap upon retraction of the mud flap within the mud flap extension bar.

According to further aspects of the present teaching, the adjustable mud flap assembly may be electrically connected to the vehicle and may include an automated system which allows the adjustable mud flap assembly to engage the motor and lift the mud flap when the vehicle is placed in reverse. In certain aspects of the present teaching, the automated system is electrically connected to the vehicles rear light circuit which is activated when the vehicle is placed in reverse.

According to other aspects of the present teaching, the automated system is electrically connected to the vehicles transmission which provides a signal to the automated system that the vehicle has been placed in reverse. In such embodiments, the operator of the vehicle may allow a period of delay between placing the vehicle in reverse and moving the vehicle in reverse to allow a sufficient amount of time for the motor of the adjustable mud flap assembly to lift or raise the mud flap out of the way of the rear wheels before moving the vehicle.

According to further aspects of the present teaching, the adjustable mud flap assembly may be electrically connected to a control unit which will allow the operator to selectively control the extension and retraction of the mud flap within the adjustable mud flap assembly independent of the vehicle's braking system. The control unit may be designed to allow the operator to electronically control the deployment or retraction of the mud flap through the push of a button. The control be located on the exterior side of the vehicle (e.g., adjacent to the adjustable mud flap assembly) or within the interior of the vehicle (e.g., within the cab of a truck).

According to further aspects of the present teaching, the adjustable mud flap assembly may include brake, tail and turn lights which are installed on the mud flap extension bar (14). The brake lights may be electrically connected to the vehicles braking system so that the brake lights illuminate when the vehicle's brakes are applied or when the vehicle is placed in reverse.

In such embodiments, the motor of the adjustable mud flap assembly may lift or retract the mud flap when the brake lights illuminate and the vehicle is placed in reverse. One advantage of installing brake, tail and turn lights on the adjustable mud flap assembly is that the vehicle will have a secondary rear lighting system in the event that the vehicle's primary rear lighting system fails.

In other cases, the rear lighting system (including brake lights, tail lights and turn lights) installed on the adjustable mud flap assembly may function as the vehicle's primary rear lighting system. Having brake lights, tail lights and turn lights installed on the adjustable mud flap assembly also provides a safeguard ensuring that the vehicle is in compliance with Department of Transportation requirements with respect to having functioning brake, tail and turn lights.

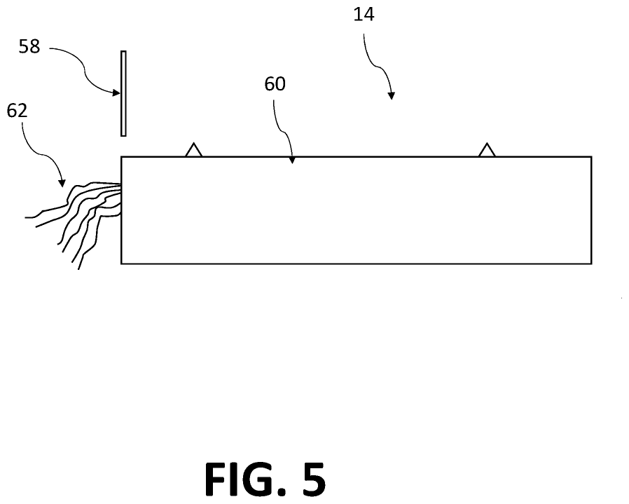

An exemplary embodiment of a rear lighting system is illustrated in FIG. 5. As shown within FIG. 5, the rear lighting system (60) is attached to a mud flap extension bar (14) which extends outward from a mount plate (58). At the mounting plate side of the mud flap extension bar, wiring (62) is inserted through an aperture within the mount plate (58) within the interior portion of the mud flap extension bar (14) to electrically connect the rear lighting system (60) to the vehicle's electrical system. As further shown in the embodiment shown in FIG. 5, the rear lighting system (60) is attached to a corner edge of a channel which comprises the mud flap extension bar (14). Various wires may be included within the wiring harness connecting the rear lighting system (60) to the vehicle's electrical system including a red wire for activating the brake lights, a green/yellow wire for activating the turn signal, a brown wire for activating the tail lights and a white wire for ground as shown within FIG. 5.

As further shown within FIG. 5, the rear lighting system (60) may include two light assemblies positioned adjacent to one another on the mud flap extension bar. These two light assemblies may be referred to as a first light assembly and a second light assembly.

According to certain aspects of the present teaching, the first and second light assembly may be differentiated from each other so that one light assembly shines brighter than the other, so that one light assembly shines a different color than the other or so that one light assembly blinks when activated in order to provide the functions of a brake light, a turn signal light or a tail light. FIG. 1 illustrates a perspective view of an adjustable mud flap assembly (10) in assembled form. The adjustable mud flap assembly (10) shown in FIG. 1 includes a mud flap (16) which extends downward from an opening (not shown) at the bottom side of a mud flap extension bar (14). The mud flap extension bar (14) includes a first end connected to a motor housed within a motor housing (12) and a second end having a removable end cap and an adjuster (18) (e.g., a socket, screw or drive square) which allows an operator to manually rotate a drive bar positioned within the mud flap extension bar (14).

FIG. 2 illustrates the drive bar (22) that is positioned within the mud flap extension bar (14). The drive bar (22) includes a series of threaded holes (26) which are used to secure a sheet of mud flap material (16) to the drive bar (22) with a fastener. Also illustrated within FIG. 2 is an adjuster shaft (24) connected to the second end of the drive bar (22). The adjuster shaft (24) includes a ½″ drive square at its end face which allows an operator to manually rotate that drive bar (22) in order to extend or retract the mud flap (16).

FIG. 3 is a perspective view of the second end (i.e., the free end) of the mud flap extension bar (14). As shown within FIG. 3, the second end or free end of the mud flap extension bar includes an end cap or cover plate (30) which is secured to the mud flap extension bar by a series of bolts (32).

FIG. 4 illustrates an inside back view of a mud flap extension bar (14) having a hexagonal shaped fitting (40) for receiving a hexagonal shaped end extending from the motor drive shaft and a sealed bearing (42) surrounding the drive bar (22) within the mud flap extension bar (14).

As described above, the present disclosure has been described with preferred embodiments thereof and it is understood that many changes and modifications to the described embodiments can be carried out without departing from the scope and the spirit of the present disclosure that is intended to be limited only by the appended claims.

What is claimed is:

1. An adjustable mud flap assembly, the adjustable mud flap assembly comprising:
a motor, the motor having a motor housing;
a mud flap extension bar coupled to the motor housing;
a sheet of mud flap material wrapped around a drive bar, wherein the drive bar being housed within the mud flap extension bar; and
a motor drive shaft, the motor drive shaft being rotatable for driving operation of a drive bar, and wherein an extension or retraction of the mud flap material being from an opening at the bottom side of the mud flap extension bar.

2. The assembly of claim 1, wherein the mud flap extension bar further comprising an adjuster.

3. The assembly of claim 2, wherein the adjuster being a drive square.

4. The assembly of claim 1, wherein the mud flap material being coupled to the mud flap extension bar by a fastener.

5. The assembly of claim 1, wherein the assembly further comprising:
an adjuster shaft being coupled to a second end of the drive bar.

6. The assembly of claim 5, the adjuster shaft further comprising an adjuster.

7. The assembly of claim 6, wherein the adjuster being a drive square.

8. The assembly of claim 1, the assembly further comprising:
a rear light assembly, the rear light assembly being coupled to the mud flap extension bar.

9. The assembly of claim 8, wherein the rear light assembly being extended outward from a mount plate.

10. The assembly of claim 8, wherein the rear light assembly further comprising a wire harness, the wire harness being for holding a plurality of wires.

11. The assembly of claim 10, wherein the plurality of wires being further coupled to a vehicles electrical system.

12. The assembly of claim 10, wherein one of the plurality of wires being a red wire for activating brake lights.

13. The assembly of claim 1, wherein one of the plurality of wires being a green/yellow wire for activating a turn signal.

14. The assembly of claim 1, wherein one of the plurality of wires being a brow wire for activating tail lights.

15. The assembly of claim 1, wherein one of the plurality of wires being a white wire for grounding of the vehicle's electrical system.
